(19) United States
(12) Patent Application Publication
(10) Pub. No.: US 2003/0182194 A1
(43) Pub. Date: Sep. 25, 2003

(54) Method and system of transaction card fraud mitigation utilizing location based services

(76) Inventors: Mark Choey, Teaneck, NJ (US); Daniel Schutzer, Scarsdale, NY (US); David Schreiber, Chappaqua, NY (US)

Correspondence Address: KILPATRICK STOCKTON LLP, 607 14TH STREET, N.W., SUITE 900, WASHINGTON, DC, 20005, US

(21) Appl. No.: 10/355,413

(22) Filed: Jan. 31, 2003

Related U.S. Application Data
(60) Provisional application No. 60/355,454, filed on Feb. 6, 2002.
(60) Provisional application No. 60/355,445, filed on Feb. 7, 2002.

(51) Int. Cl. G06F 17/60

(52) U.S. Cl. 705/16; 705/18

(57) ABSTRACT

A method and system of transaction card fraud mitigation utilizes location based services provided by a card holder's wireless carrier for verification of whether or not a transaction with the card holder's transaction card is fraudulent. For example, when factors indicative of a likelihood of a fraudulent transaction with the card holder's transaction card are present, the card processing system requests the card holder's wireless carrier to return the location information of the card holder's mobile phone, which is typically on the person of the subscriber. When the location of the subscriber's mobile phone is returned and determined to be at or near the location from which the transaction is being attempted with the transaction card, the card processing system has a reasonable degree of confidence that the particular transaction is or is not fraudulent and allows the transaction to proceed. Otherwise, the transaction is denied.

### PRIORITY APPLICATION

This application claims the benefit of U.S. Provisional Application No. 60/355,454 filed Feb. 6, 2002, entitled “A Method and System of Fraud Elimination Using LBS,” and U.S. Provisional Application No. 60/355,445 filed Feb. 7, 2002, entitled “A Method and System of Fraud Elimination Using LBS,” both incorporated herein by this reference

### FIELD OF THE INVENTION

The present invention relates generally to the field of transaction cards, and more particularly to a method and system for mitigating the risk of transaction card fraud and/or confirming identification, for example, for access purposes using location based services of a mobile phone carrier.

### BACKGROUND OF THE INVENTION

According to one of the early-warning credit card fraud detection procedures presently in use, when factors that indicate a likelihood of a fraudulent transaction card transaction are detected, typically the transaction is denied and the merchant is requested to call in to verify the card holder's details and confirm that he/she is actually present. When the merchant calls in, the credit card processing system may have a conversation with the card holder to verify his or her identity and to confirm that the card user is actually the authorized holder of the transaction card. For example, the merchant's point of sale terminal accepts the credit card information through swiping or manual input and makes a phone call or is directly connected to the credit card processing system. The information is received by the processing system which runs it through a fraud detection system that utilizes certain predefined parameters, such as where the store is located in relation to the card holder's home zip code, the fraud risk for this type of store, the number of transactions within the past 24 hours with the card, and the amount of the transaction relative to an authorization amount for the card. For example, certain types of stores have a greater vulnerability to fraudulent transactions and typically raise red flags of attempted use of a stolen credit card. Other factors include, for example, a dollar amount that is quite large or perhaps unusual transaction activity, such as many purchases being made within the same day, and/or the customer usage pattern of the card holder. Depending on factors, such as the transaction amount and/or the store location, the transaction may be flagged by the credit card processor's fraud detection system, in which case the processing system denies the transaction and requires the merchant or the card holder to call in to verify the card holder's identity before allowing the transaction to proceed.

The current system is extremely costly in terms of call handling and customer service and can also be a source of customer satisfaction problems when denying otherwise valid transactions.

### SUMMARY OF THE INVENTION

It is a feature and advantage of the present invention to provide a method and system for mitigating the risk of transaction card fraud using location based services of a mobile phone carrier that captures a high proportion of fraud attempts while reducing the false-positives rate.

It is another feature and advantage of the present invention to provide a method and system for mitigating the risk of transaction card fraud using location based services of a mobile phone carrier that can detect the attempted use of a counterfeit transaction card.

It is an additional feature and advantage of the present invention to provide a method and system for mitigating the risk of transaction card fraud using location based services of a mobile phone carrier that saves substantial costs in terms of call handling.

It is a further feature and advantage of the present invention to provide a method and system for mitigating or eliminating transaction card fraud using location based services of a mobile phone carrier that affords considerable savings in terms of customer service and greatly increases customer satisfaction by allowing valid transactions that might otherwise be denied.

It is still another feature and advantage of the present invention to provide a method and system for confirming identification, for example, for access purposes using location based services of a mobile phone carrier.

To achieve the stated and other features, advantages and objects, the method and system for an embodiment of the present invention enables the verification of whether or not a transaction with a transaction card, such as a credit card, charge card, debit card, and/or ATM card, is fraudulent using location based services provided by the card holder's wireless carrier. For example, when a transaction card processing system of a financial institution, such as a bank, detects that a transaction is suspected of being fraudulent, the processing system requests the wireless carrier to return the location information of the cell phone of the card holder, which is typically on the person of the cell phone subscriber. When the location of the subscriber's cell phone is returned and determined to be at or near the location from which the transaction is being attempted with the transaction card, the card processing system has a reasonable degree of confidence that the particular transaction is or is not fraudulent.

According to a credit card fraud mitigation aspect of an embodiment of the present invention, transaction card information for a user, such as credit card information, in connection with a transaction attempted by the user at a user location is received by a transaction card processing system, for example, via a merchant's point-of-sale terminal disposed at the user location. The information is received, for example, through swiping the card through a card reader of the terminal or by manual input and sent to the transaction card processing system via a phone call by the merchant's point-of-sale terminal to the transaction card processing system or a direct connection between the merchant's point-of-sale terminal and the transaction card processing system.

In the credit card fraud mitigation aspect, a fraud detection system of the transaction card processing system evaluates the transaction card information according to pre-defined parameters for detecting factors indicative of the likelihood of a fraudulent transaction, and if such factors are identified by the fraud detection system, the transaction is flagged by the fraud detection system as likely to be fraudulent. If the transaction is flagged, a request is sent by the transaction card processing system to a wireless carrier of a mobile phone of a holder of the transaction card to return location information of the card holder's mobile phone utilizing location based services provided by the wireless carrier.

In a compromised credit card aspect of an embodiment of the invention, if information is received by the transaction card processing system that the card holder's transaction card has been, for example, counterfeited or otherwise compromised, the transaction card processing system simply flags all transactions with the card holder's card and sends a request to the card holder's wireless carrier to return location information of the card holder's mobile phone in all transactions with the compromised card. In either aspect, when the location information for the card holder's mobile phone is received by the transaction card processing system, if the location of the card holder's mobile phone is determined to be at or near the merchant's point-of-sale terminal at the user location, the transaction is allowed to proceed by the transaction card processing system. Otherwise, if the location of the card holder's mobile phone is determined to be at a location other than proximate the user location, the transaction is denied by the transaction card processing system.

In an ATM card fraud mitigation aspect of the invention, transaction card information for the user, such as ATM card information, in connection with a transaction attempted by the user at the user location is received, for example, by an ATM card processing system via an ATM machine or merchant point-of-sale terminal disposed at the user location. If factors indicative of a likelihood of a fraudulent transaction, such as multiple attempts to enter incorrect card holder identification or PIN information by the card user, the ATM card processing system sends a request to the card holder's wireless carrier to return location information of the card holder's mobile phone utilizing its location based services. When the location information is received by the ATM card processing system, if the location of the card holder's mobile phone is determined to be at or near the ATM machine at the user location, the transaction is allowed to proceed by the ATM card processing system. On the other hand, if the location of the card holder's mobile phone is determined to be at a location other than proximate the ATM machine, the transaction is denied.

In an on-line or phone order credit card fraud mitigation aspect of the invention, transaction card information for the user, such as credit card information, in connection with a transaction attempted by the user at the user location is received by the transaction card processing system, for example, via a network connected computing device or a land line connected telephonic device disposed at the user location. In this aspect, the user location is approximated by the transaction card processing system via a trace of the location of the network connected computing device or the land line connected telephonic device. If the approximation of the user location determines the user location to be outside a pre-defined home geographic area of the card holder, the transaction card processing system flags the transaction as likely to be fraudulent. Upon flagging the transaction, the transaction card processing system sends a request to the card holder's wireless carrier to return location information of the mobile phone of the card holder utilizing its location based services. When the location information is received by the transaction card processing system, if the location of the card holder's mobile phone is determined to be at or near the respective approximated location of the network connected computing device or the land line connected telephonic device at the user location, the transaction is allowed to proceed by the transaction card processing system. However, if the location of the card holder's mobile phone is determined to be other than at or near the respective approximated location of the network connected computing device or the land line connected telephonic device, the transaction is denied.

In an access control aspect of an embodiment of the invention, transaction card information for the user, such as access control or key card information, in connection with a transaction, such as access to secure premises, attempted by the user at the user location is received by an access control card system via an access control terminal disposed at the user location, for example, through swiping the card through a card reader of the terminal. The access control card processing system sends a request to the wireless carrier of the mobile phone of the card holder to return location information of the card holder's mobile phone utilizing its location based services. Upon receiving the location information for the card holder's mobile phone, if the location of the card holder's mobile phone is determined to be at or near the access control terminal at the user location, the access control card processing system allows the access transaction to proceed. On the other hand, if the location of the card holder's mobile phone is determined to be at a location other than proximate the access control terminal, the access transaction is denied.

Additional objects, advantages and novel features of the invention will be set forth in part in the description which follows, and in part will become more apparent to those skilled in the art upon examination of the following, or may be learned from practice of the invention.

### BRIEF DESCRIPTION OF THE DRAWINGS

FIG. 1 is a schematic diagram that illustrates an example overview of key components and the flow of information between key components of the system for an embodiment of the present invention utilizing location based services of a subscriber's wireless carrier for mitigation of transaction card fraud;

FIG. 2 is a flow chart that illustrates an example of the process of using location based services of the subscriber's wireless carrier to mitigate transaction card fraud according to an embodiment of the present invention;

FIG. 3 is a flow chart that illustrates an example of the process of using location based services of the subscriber's wireless carrier to detect counterfeit transaction cards according to an embodiment of the present invention;

FIG. 4 is a schematic diagram that illustrates an example overview of key components and the flow of information between key components of the system for an embodiment of the present invention utilizing location based services of a subscriber's wireless carrier for mitigation of ATM card fraud;

FIG. 5 is a flow chart that illustrates an example of the process of using location based services of the subscriber's wireless carrier to mitigate ATM card fraud according to an embodiment of the present invention;

FIG. 6 is a schematic diagram that illustrates an example overview of key components and the flow of information between key components of the system for an embodiment of the present invention utilizing location based services of a subscriber's wireless carrier to mitigate online and/or phone mail order transaction card fraud;

FIG. 7 is a flow chart that illustrates an example of the process of using location based services of the subscriber's wireless carrier to mitigate online and/or phone mail order transaction card fraud according to an embodiment of the present invention;

FIG. 8 is a schematic diagram that illustrates an example of an example overview of key components and the flow of information between key components of the system for an embodiment of the present invention utilizing location based services of a subscriber's wireless carrier to control entry to physically secure premises to which access is controlled;

FIG. 9 is a flow chart that illustrates an example of the process of using location based services of the subscriber's wireless carrier to control entry to physically secure premises to which access is controlled according to an embodiment of the present invention; and

FIG. 10 is a grid on which are illustrated four examples of what can happen in a fraud detecting system for an embodiment of the present invention.

### DETAILED DESCRIPTION

Referring now in detail to an embodiment of the present invention, an example of which is illustrated in the accompanying drawings, the present invention utilizes computer hardware and software to provide a method and system for mitigating or eliminating transaction card fraud using location based services of a mobile phone carrier. Currently, on a worldwide basis, mobile or wireless phone carriers have, or are implementing, a capability for providing systems through which the location of an individual's wireless phone can be tracked with a considerable degree of accuracy. This capability was driven, for example, by a U.S government mandate, known as E911, that requires the ability to determine the location within a reasonable degree of accuracy of cell phones from which emergency calls, such as 911 calls, are received. Presently, numerous commercial applications are being developed from this new type of functionality. For example, using location based services provided by the wireless carrier, an embodiment of the present invention enables the verification of whether or not a credit card transaction is fraudulent.

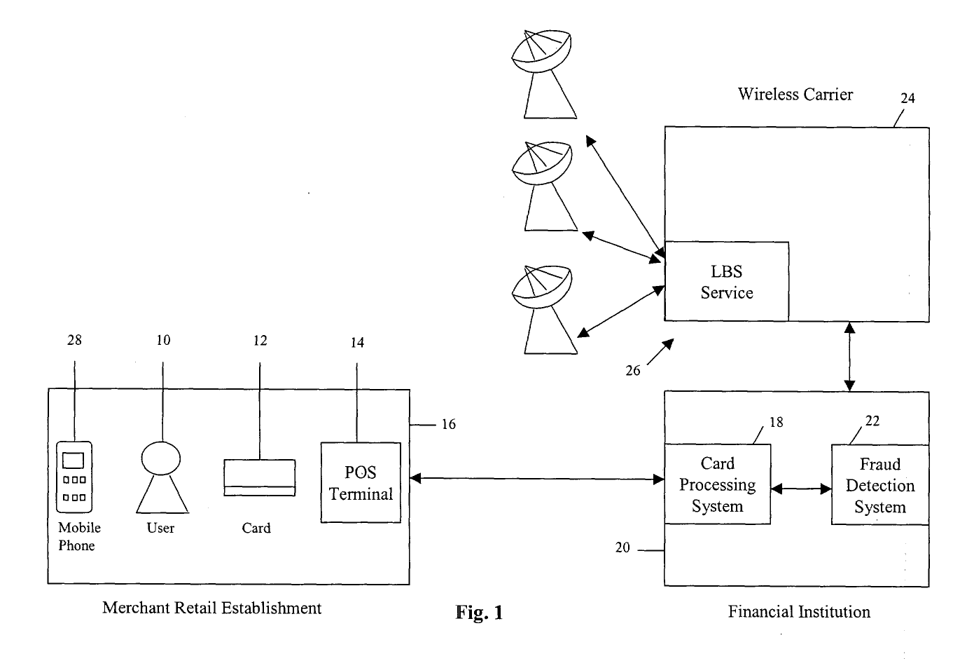

FIG. 1 is a schematic diagram that illustrates an example overview of key components and the flow of information between key components of the system for an embodiment of the present invention using location based services of a subscriber's wireless carrier for mitigation of credit card fraud. A card holder 10 who uses a credit card 12, for example, at a POS terminal 14 of a particular retail establishment 16 is typically physically present at the location of the establishment 16. When the card holder 10 goes to the retail store 16 and uses his or her credit card 12, the credit card processing system 18 of a financial institution 20, such as a bank, may detect that the transaction is suspicious, for example, through the dollar amounts or the type of store at which the credit card 12 is being used. According to whatever parameters the credit card processing system 18 currently uses to detect a transaction as being fraudulent, the transaction is flagged by the fraud detection system 22 of the card processor 18 as being fraudulent. As a way to reduce the incidence of false positives, which means the false detections of non-fraudulent transactions as being fraudulent, upon detecting a transaction suspected of being fraudulent, in an embodiment of the present invention, the credit card processing system 18 requests the wireless carrier 24, using its location based service 26, to return the location information of the cell phone 28 of the card holder 10, which is typically on the person of the cell phone subscriber 10. If the location of the card holder's cell phone 28 is returned and determined to be at or near the same location as the point of sale terminal 14 where the purchase is being made with the credit card 12, the credit card processing system 18 has a reasonable degree of confidence that the particular transaction is not fraudulent.

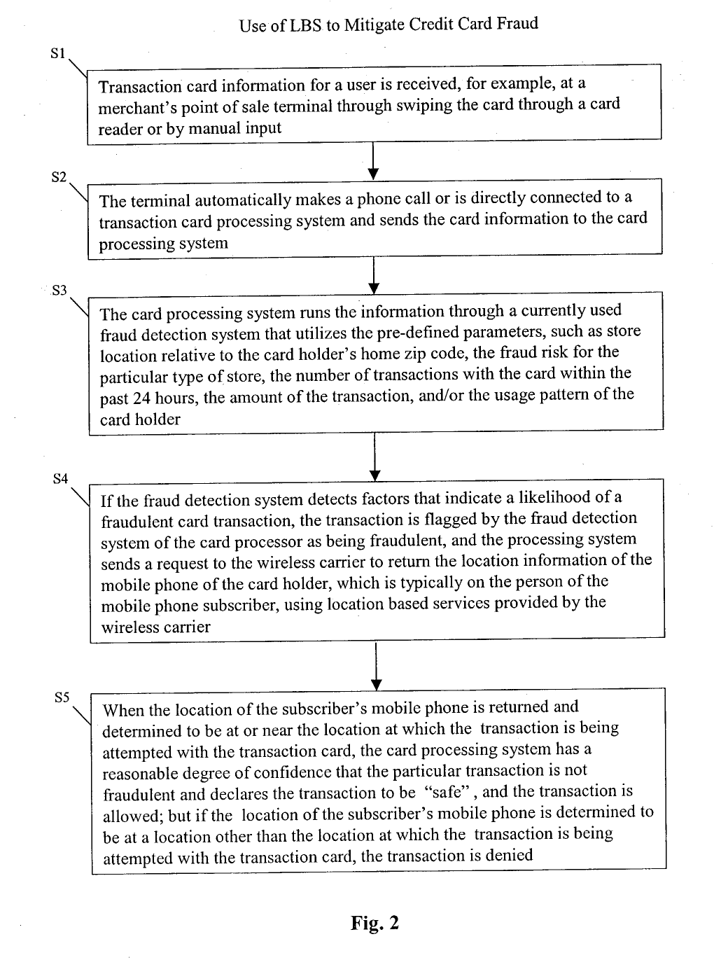

FIG. 2 is a flow chart that illustrates an example of the process of using location based services of the subscriber's wireless carrier to mitigate transaction card fraud according to an embodiment of the present invention. Referring to FIGS. 1 and 2, at S1, transaction card information for the user 10 is received, for example, at the merchant's point of sale terminal 14 through swiping the card 12 through a card reader or by manual input. At S2, the terminal automatically makes a phone call or is directly connected to the transaction card processing system 18 and sends the card information to the card processing system 18. At S3, the card processing system 18 runs the information through a currently used fraud detection system 22 that utilizes typical parameters pre-defined for detecting likelihood of fraud. At S4, if the fraud detection system 22 detects factors that indicate a likelihood of a fraudulent card transaction, the transaction is flagged by the fraud detection system 22 of the card processor 18 as being fraudulent, and the processing system 18 requests the wireless carrier 24 to return the location information of the mobile phone 28 of the card holder 10, using location based services 26 provided by the wireless carrier 24. At S5, when the location of the subscriber's mobile phone 28 is returned and determined to be at or near the location at which the transaction is being attempted with the transaction card 12, the card processing system 18 has a reasonable degree of confidence that the particular transaction is not fraudulent and declares the transaction to be “safe”, and the transaction is allowed. However, if the location of the subscriber's mobile phone 28 is determined to be at a location other than the location at which the transaction is being attempted with the transaction card 12, the transaction is denied.

Another type of credit card fraud that the system for an embodiment of the present invention can detect that current systems are incapable of detecting are counterfeit credit cards. If an unauthorized individual obtains or fabricates a counterfeit credit card of a card holder and attempts to use it in a transaction, current systems cannot detect this particular type of transaction. The purchase may be quite normal and not raise any red flags, but the transaction card itself is a fraudulent card. The system of the present invention can detect this situation using the location based service of the mobile phone carrier to verify the location of the card holder's cell phone in relation to the credit card. In order to flag this type of fraudulent transaction, it is necessary for the credit card company to flag all transactions in which the cell phone is not in proximity to the credit card.

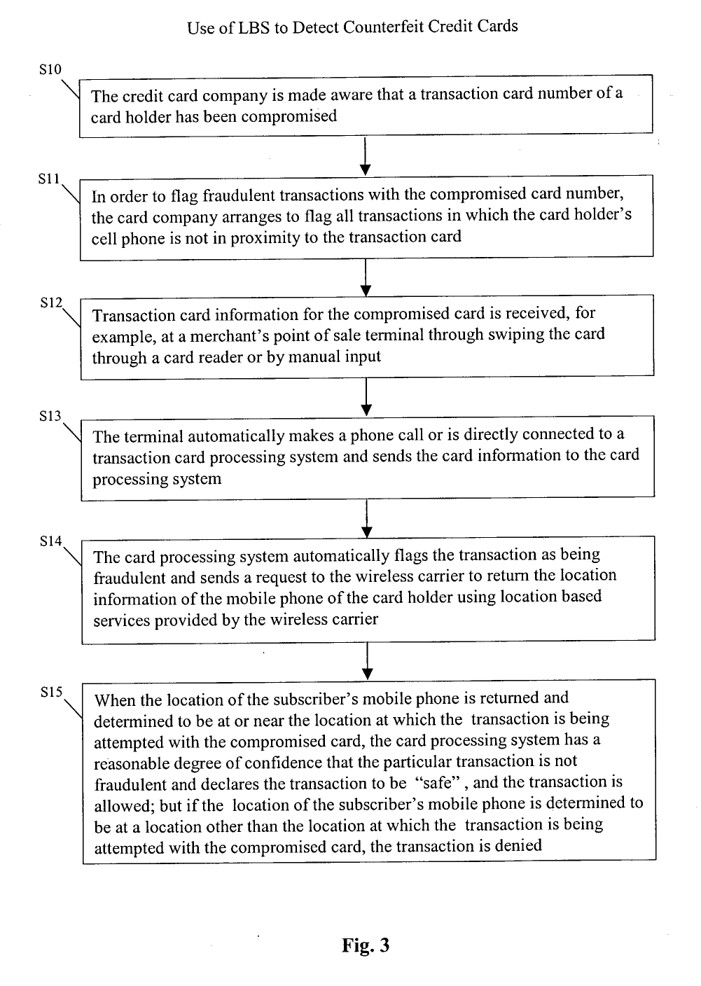

FIG. 3 is a flow chart that illustrates an example of the process of using location based services of the subscriber's wireless carrier to detect counterfeit credit cards according to an embodiment of the present invention. Referring to FIGS. 1 and 3, at S10, the credit card company 20 is made aware that a transaction card number of the card holder 10 has been compromised. At S11, in order to flag fraudulent transactions with the compromised card number, the card company 20 arranges to flag all transactions with the compromised transaction card 12. At S12, transaction card information for the compromised card 12 is received, for example, at the merchant's point of sale terminal 14 through swiping the card 12 through the card reader or by manual input. At S13, the terminal 14 automatically makes a phone call or is directly connected to the transaction card processing system 18 and sends the card information to the card processing system 18. At S14, the card processing system 18 automatically flags the transaction as being fraudulent and requests the wireless carrier 24 to return the location information of the mobile phone 28 of the card holder 10 using location based services 26 provided by the wireless carrier 24. At S15, when the location of the subscriber's mobile phone 28 is returned and determined to be at or near the location at which the transaction is being attempted with the compromised card 12, the card processing system 18 has a reasonable degree of confidence that the particular transaction is not fraudulent and declares the transaction to be “safe”, and the transaction is allowed. On the other hand, if the location of the subscriber's mobile phone 28 is determined to be at a different location than the location at which the transaction is being attempted with the compromised card 12, the transaction is denied.

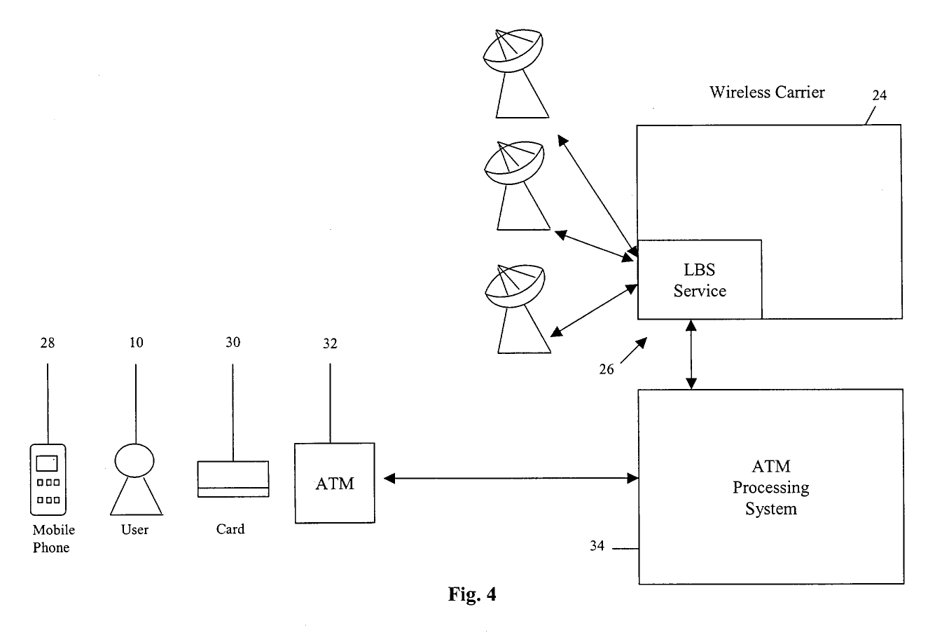

A further aspect of the present invention relates to ATM transactions. FIG. 4 is a schematic diagram that illustrates an example overview of key components and the flow of information between key components of the system for an embodiment of the present invention using location based services of a subscriber's wireless carrier for mitigation of ATM card fraud. If a user 10 with an ATM card 30 does something suspicious, such as entering the wrong PIN several times at an ATM terminal 32, according to an embodiment of the present invention, after a predetermined number of incorrect attempts, an automatic location of the card holder's cell phone 28 can be performed via the location based service 26 of the mobile phone carrier 24 to see if the ATM card holder's cell phone 28 is indeed at or near the location of the particular ATM 32. If it is, there is less likelihood of the transaction being a fraudulent ATM transaction, because the card holder 10 is in the vicinity of the ATM card 30. However, if the PIN is being incorrectly entered multiple times and the card holder's cell phone 28 is not in the vicinity of the ATM card 30, that raises a red flag and, for example, withdrawal of funds from the ATM 32 can be prevented.

Presently, if an ATM card user 10 enters the PIN number incorrectly a predetermined number of times, use of the ATM card 30 is simply locked out and the card 30 is blocked, for example, until the customer 10 calls the customer service center and gets it unlocked or is reissued an entirely new card. However, determination of the location of the card holder's cell phone 28, for example, after the first incorrect entry, eliminates the necessity of blocking the card 30. Thus, rather than locking the card 30 out after a predetermined number of incorrect entries, the location of the card holder's cell phone 28 can be checked after the first or second incorrect entry, and if it is in the same location as the card 30, it may not be necessary to lock the card 30 out at all.

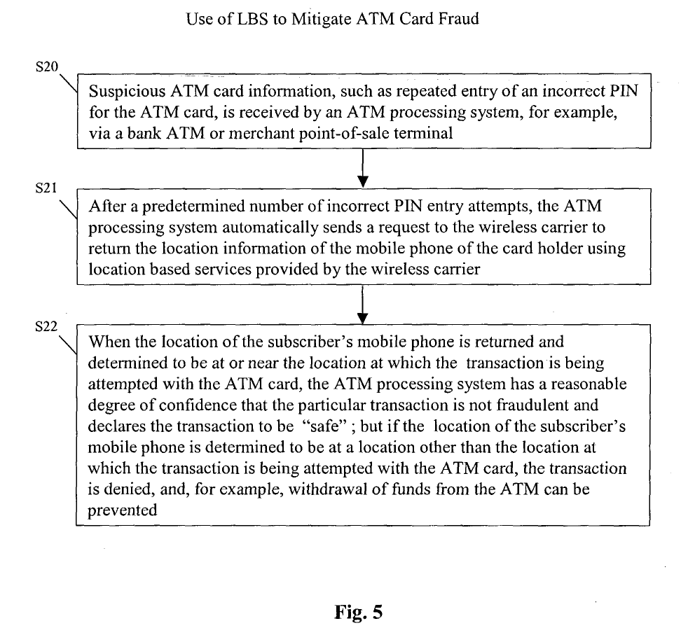

FIG. 5 is a flow chart that illustrates an example of the process of using location based services of the subscriber's wireless carrier to mitigate ATM card fraud according to an embodiment of the present invention. Referring to FIGS. 4 and 5, at S20, suspicious ATM card information, such as repeated entry of an incorrect PIN for the ATM card 30, is received by an ATM processing system 34, for example, via a bank ATM 32 or merchant point-of-sale terminal. At S21, after a predetermined number of incorrect PIN entry attempts, the ATM processing system 34 automatically requests the wireless carrier 24 to return the location information of the mobile phone 28 of the card holder 10 using location based services 26 provided by the wireless carrier 24. At S22, when the location of the subscriber's mobile phone 28 is returned and determined to be at or near the location at which the transaction is being attempted with the ATM card 30, the ATM processing system 34 has a reasonable degree of confidence that the particular transaction is not fraudulent and declares the transaction to be “safe”. However, if the location of the subscriber's mobile phone 28 is determined to be at a different location than the location at which the transaction is being attempted with the ATM card 30, the transaction is denied, and withdrawal of funds from the ATM 32 can be prevented.

In addition to detecting and avoiding fraudulent ATM transactions, the increased security provided by the system of an embodiment of the present invention enables a financial institution, for example, to raise the limit on the amount of funds that participating ATM card holders can withdraw daily at an ATM. For example, a typical bank policy may limit the amount of cash that an ATM card holder can withdraw from an ATM to a maximum of $300 per day. However, a participating ATM card holder who consents to use of the method and system of the present invention can be allowed to withdraw up to a maximum, for example, of $1,000 a day because of the increased likelihood that the card user is in fact the authorized card holder.

Another aspect of the present invention is pre-registration, since allowing a third party to be able to detect the location of a cell phone subscriber raises privacy concerns. Thus, when an individual subscribes or signs up with a financial institution for a credit card account utilizing the method and system for an embodiment of the present invention, a waiver or disclaimer is obtained by which the financial institution reserves the right, and the card holder explicitly agrees, to the use of location based services to detect the location of the card holder's cell phone anytime a fraudulent card transaction has been detected by the card processing system.

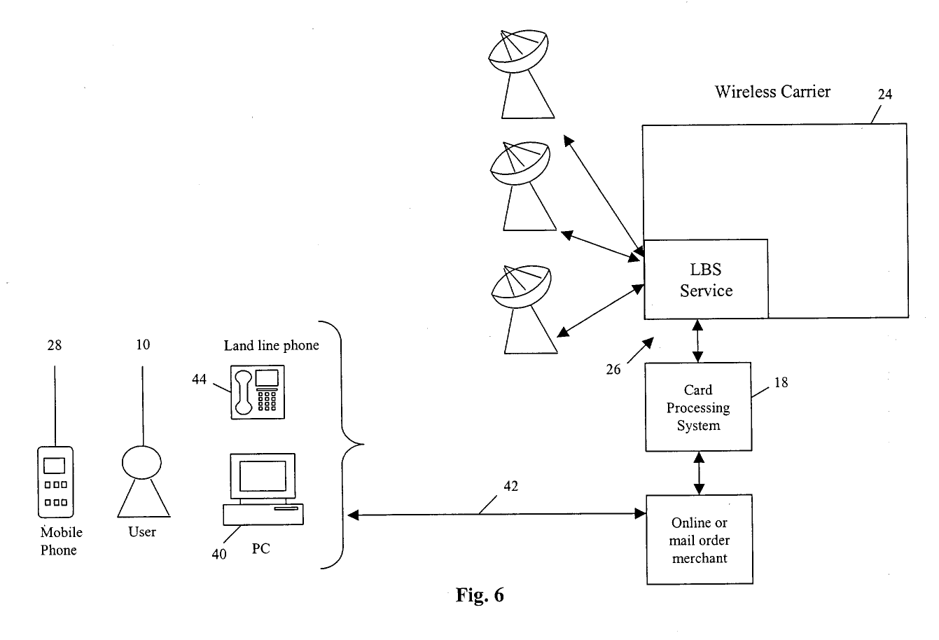

Although physical presence at an ATM, telephone, or point of sale terminal is helpful, it is not required, and online or telephone mail order transactions can also be screened using the system for an embodiment of the present invention. FIG. 6 is a schematic diagram that illustrates an example overview of key components and the flow of information between key components of the system for an embodiment of the present invention using location based services of a subscriber's wireless carrier to mitigate online and phone mail order transaction card fraud. Referring to FIG. 6, the location of a card user 10 that is online using an Internet connected computer 40 (either dialup, office connection, home broadband connection, or wireless connection) can be approximated by tracing the card user's network path 42. Similarly, a geographic location of a mail order call on land line phone 44 an also be obtained as well. Correlating the approximated location of the caller 10 with the location of the card holder's cell phone 28 can greatly reduce the risk of fraud, as fraud can come very often from outside the card holder's home zip code area.

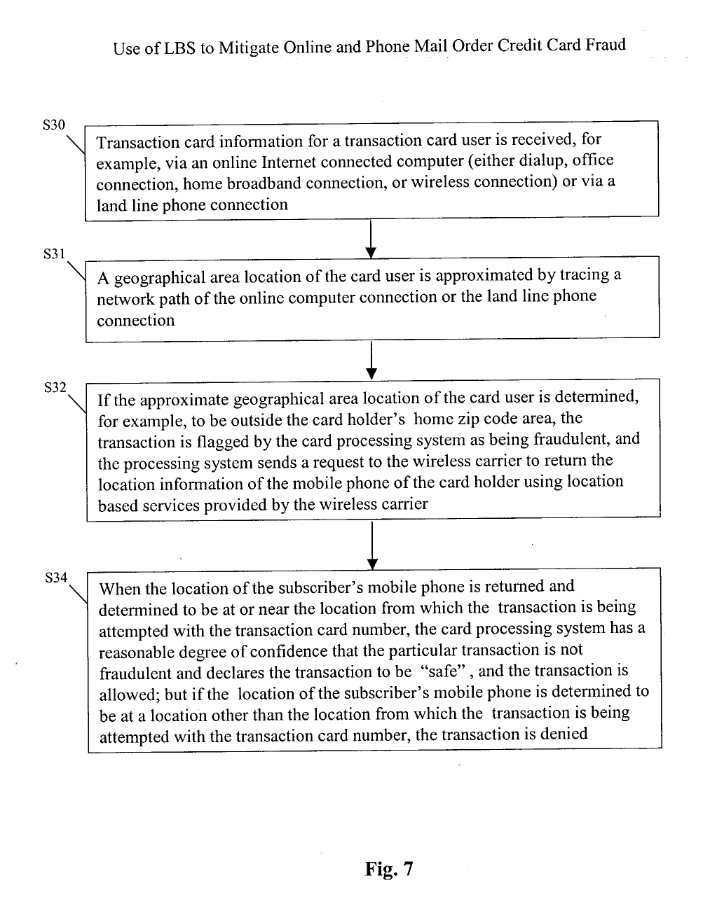

FIG. 7 is a flow chart that illustrates an example of the process of using location based services of the subscriber's wireless carrier to mitigate online and/or phone mail order transaction card fraud according to an embodiment of the present invention. Referring to FIGS. 6 and 7, at S30, transaction card information for the transaction card user 10 is received, for example, via an online Internet connected computer 40 (either dialup, office connection, home broadband connection, or wireless connection) or via a land line phone connection 44. At S31, a geographical area location of the card user 10 is approximated by tracing a network path 42 of the online computer connection 40 or the land line phone connection 44. At S32, if the approximate geographical area location of the card user 10 is determined, for example, to be outside the card holder's home zip code area, the transaction is flagged by the card processing system 18 as being fraudulent, and the processing system 18 requests the wireless carrier 24 to return the location information of the mobile phone 28 of the card holder 10 using location based services 26 provided by the wireless carrier 24. At S33, when the location of the subscriber's mobile phone 28 is returned and determined to be at or near the approximate geographic location from which the transaction is being attempted with the transaction card number, the card processing system 18 has a reasonable degree of confidence that the particular transaction is not fraudulent and declares the transaction to be “safe”, and the transaction is allowed. If, on the other hand, the subscriber's mobile phone 28 is determined to be at a different location than the location from which the transaction is being attempted with the transaction card number, the transaction is denied

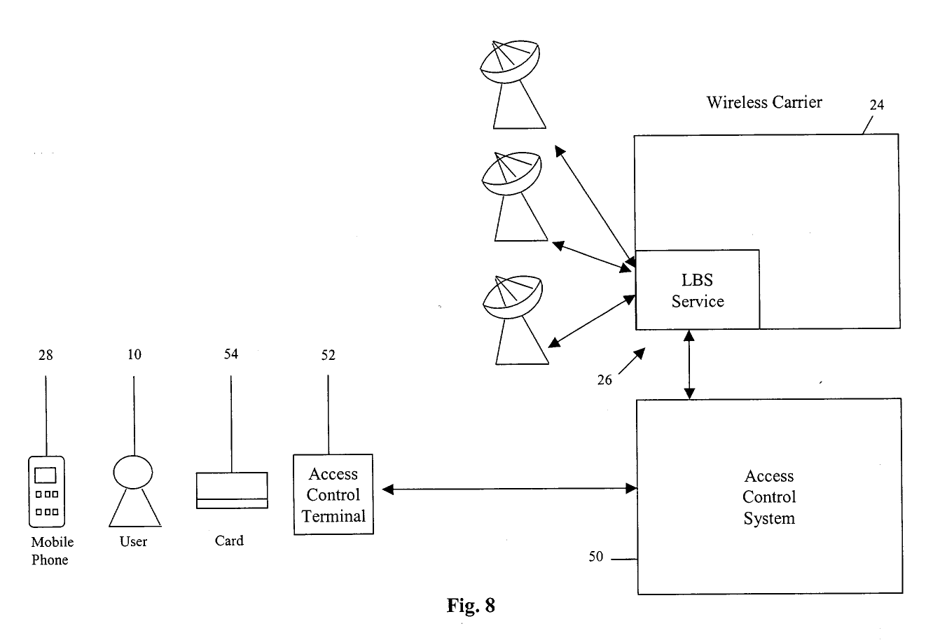

It is to be understood that all references herein to “card”, “transaction card”, “credit card”, “charge card”, “debit card”, and/or “ATM card” include, without limitation, bank cards, credit cards, charge cards, debit cards, ATM cards, telephone cards, identification cards, hotel cards, key cards, access cards, club cards, affinity cards, travel cards, and the like. It is also to be understood that embodiments of the present invention described herein are not limited, for example, to use of financial transaction cards, such as credit cards and ATM cards, but also include the general concept of using, for example, the triangulation functionality of location based services of a mobile phone carrier, or any other methods of finding the location of mobile devices, and including, without limitation, manual entry, to confirm the identification of a participating individual, for example, as an aspect of allowing entry to physically secure premises to which access is controlled, such as at an airport. FIG. 8 is a schematic diagram that illustrates an example overview of key components and the flow of information between key components of the system for to an embodiment of the present invention using location based services of a subscriber's wireless carrier to control entry to physically secure premises to which access is controlled.

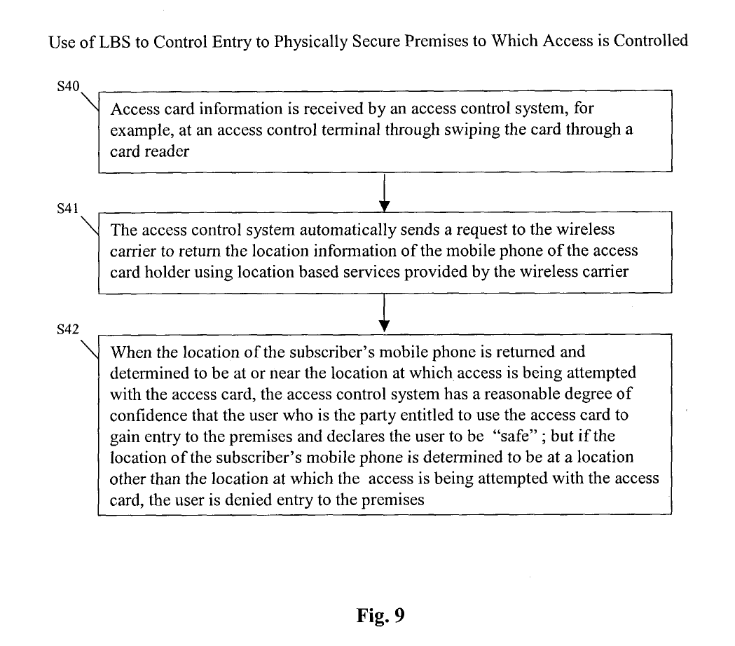

FIG. 9 is a flow chart that illustrates an example of the process of using location based services of the subscriber's wireless carrier to control entry to physically secure premises to which access is controlled according to an embodiment of the present invention. Referring to FIGS. 8 and 9, at S40, access card information is received by an access control system 50, for example, at an access control terminal 52 through swiping the access card 54 through a card reader of the terminal 52, and at S41, the access control system 50 automatically sends a request to the wireless carrier 24 to return the location information of the mobile phone 28 of the access card holder 10 using location based services 26 provided by the wireless carrier 24. At S42, when the location of the subscriber's mobile phone 28 is returned and determined to be at or near the location at which access is being attempted with the access card 54, the access control system 50 has a reasonable degree of confidence that the user who is attempting access is the party entitled to use the access card 54 to gain entry to the premises and declares the user 10 to be “safe”. However, if the subscriber's mobile phone 28 is determined to be at a different location than the location at which the access is being attempted with the access card 54, the user 10 is denied entry to the premises.

The mobile phone carrier's location based services 26 makes use, for example, of global positioning system (GPS) technology. However, the technology that is used in a GPS-enabled mobile phone system to detect mobile phone locations is a combination of conventional and custom hardware and software for the cell phone networks. The technology is somewhat different from that used, for example, in GPS-enabled vehicles. GPS requires a line of sight, so the GPS must typically be located out of doors with a clear view of sky in order to detect its satellites. Unlike a GPS-enabled vehicle, the satellites are not tracked from the cell phone itself, but instead, a fixed receiver positioned out of doors, for example, on top of a building tracks the satellites and relays that information to the GPS-enabled cell phone.

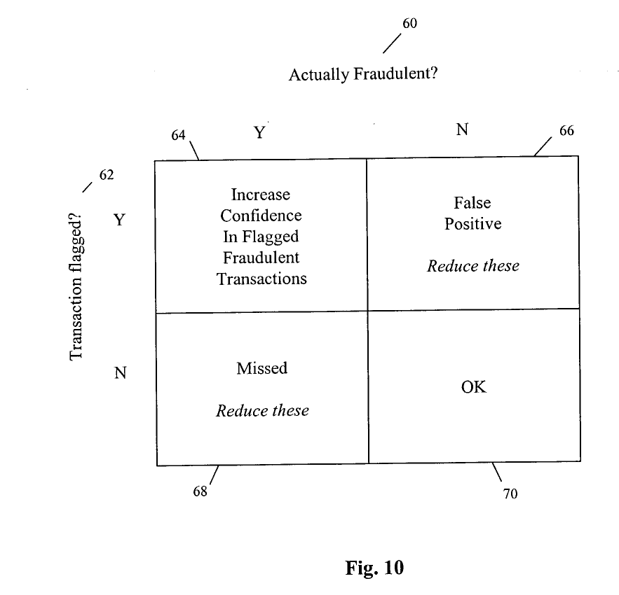

FIG. 10 is a grid on which are illustrated four cases of what can happen in a fraud detecting system for an embodiment of the present invention. Referring to FIG. 10, the horizontal axis 60 corresponds to whether or not a transaction was fraudulent, and the vertical axis 62 corresponds to whether or not the transaction was flagged. The case at the upper left quadrant 64 of the grid is a ‘YES/YES’ situation which represents a transaction that is fraudulent and flagged. The system of the present invention affords increased accuracy in this situation, because it provides another input into the decision making process. For example, when the fraud detecting system 22 indicates that a particular transaction appears to be fraudulent and should be verified, the location based services 26 functionality provided by the carrier 24 according to an embodiment of the present invention can then be used to determine whether the card holder's cell phone 28 is at or near the transaction terminal, and that information is used as another factor in deciding whether the transaction is a fraudulent transaction.

Referring further to FIG. 10, the upper right quadrant 66 of the grid represents a ‘YES/NO’ case in which the transaction is flagged but is not fraudulent. That can happen, for example, when the card holder 10 uses his or her transaction card 12 outside the country or in another part of the country. The fraud detection system 22 raises a red flag that the transaction may be a fraudulent transaction and should be verified. The system of the present invention then sends a query off to the location based services 26 of the mobile phone carrier 24 to confirm whether the card holder's cell phone 28 is indeed at or near the point of sale terminal 14, such that the probability of a fraudulent transaction is low enough for the credit card company to allow the transaction.

The system of the present invention reduces incidents of so-called false positives and saves substantial costs in terms of call handling. The present system also provides considerable savings in terms of customer service and greatly increases customer satisfaction by allowing valid transactions that might otherwise be denied. The lower left quadrant 68 of the grid represents a ‘NO/YES’ case in which a fraudulent transaction is not detected and is allowed to occur, which can be referred to as a false positive. The system of the present invention can also be used to help decrease false positives. For example, the credit card agency can implement the system of the present invention such that the threshold is higher or lower, since it enables verification of the card holder's location according to the location of his or her cell phone. The lower right quadrant 70 represents a ‘NO/NO’ case that is basically a normal transaction.

Currently, there is no simple way to verify the identity of a transaction card user other than by talking to the card user over the phone to verify that he or she is actually the authorized card holder attempting to conduct a transaction with the transaction card. Biometrics can be used, for example, at the POS terminal, ATM, or access terminal with a relatively high degree of accuracy, but that functionality is complicated and very expensive to implement, use and maintain. An embodiment of the present invention, which locates the card holder's cell phone, reduces the risk of fraud when questions arise about a card user's identity and provides a less expensive way, for example, for a credit card provider, such as a financial institution, to avoid the risk of fraudulent transaction card use than actually handling phone calls through a call handling center.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method of mitigating transaction card fraud, comprising:
receiving transaction card information for a user in connection with a transaction attempted by the user at a user location;
sending a request to a wireless carrier of a mobile phone of a holder of the transaction card to return location information of the mobile phone of the card holder utilizing location based services provided by the card holder's wireless carrier;
receiving the location information for the card holder's mobile phone from the card holder's wireless carrier;
allowing the transaction to proceed if the location of the card holder's mobile phone is determined to be proximate the user location; and
denying the transaction if the location of the card holder's mobile phone is determined to be at a location other than the user location.

2. The method of claim 1, wherein receiving the transaction card information further comprises receiving the information by a transaction card processing system via a merchant's point-of-sale terminal disposed at the user location.

3. The method of claim 2, wherein receiving the transaction card information via the merchant's point-of-sale terminal further comprises receiving the information via the merchant's point-of-sale terminal through swiping the card through a card reader of the terminal.

4. The method of claim 2, wherein receiving the transaction card information via the merchant's point-of-sale terminal further comprises receiving the information via the terminal by manual input.

5. The method of claim 2, wherein receiving the transaction card information via the merchant's point-of-sale terminal further comprises receiving the information by the transaction card processing system via a phone call by the merchant's point-of-sale terminal to the transaction card processing system.

6. The method of claim 2, wherein receiving the transaction card information via the merchant's point-of-sale terminal further comprises receiving the information by the transaction card processing system via a direct connection between the merchant's point-of-sale terminal and the transaction card processing system.

7. The method of claim 1, wherein receiving the transaction card information further comprises receiving ATM card information by an ATM card processing system via an ATM machine disposed at the user location.

8. The method of claim 1, wherein receiving the transaction card information further comprises receiving ATM card information by an ATM card processing system via a merchant point-of-sale terminal disposed at the user location.

9. The method of claim 1, wherein receiving the transaction card information further comprises receiving the transaction card information by a transaction card processing system via a network connected computing device disposed at the user location.

10. The method of claim 9, wherein receiving the transaction card information via the network connected computing device further comprises approximating the user location by the transaction card processing system via a trace of the network connected computing device.

11. The method of claim 1, wherein receiving the transaction card information further comprises receiving the transaction card information by a transaction card processing system via a land line connected telephonic device disposed at the user location.

12. The method of claim 11, wherein receiving the transaction card information via the land line connected telephonic device further comprises approximating the user location by the transaction card processing system via a trace of the land line connected telephonic device.

13. The method of claim 1, wherein receiving the transaction card information further comprises receiving access control card information by an access control card system via an access control terminal disposed at the user location.

14. The method of claim 13, wherein receiving the access control card information via the access control terminal further comprises receiving the access control card information via the access control terminal through swiping the card through a card reader of the terminal.

15. The method of claim 1, wherein sending the request to the card holder's wireless carrier further comprises sending the request to the wireless carrier by a transaction card processing system if the transaction is flagged by a fraud detection system of the transaction card processing system as likely to be fraudulent.

16. The method of claim 15, wherein sending the request to the card holder's wireless carrier further comprises flagging the transaction by the fraud detection system as likely to be fraudulent if factors indicative of the likelihood of a fraudulent transaction are identified by the fraud detection system.

17. The method of claim 16, wherein sending the request to the card holder's wireless carrier further comprises evaluating the transaction card information by the fraud detection system according to pre-defined parameters for detecting factors indicative of the likelihood of a fraudulent transaction.

18. The method of claim 1, wherein sending the request to the card holder's wireless carrier further comprises sending the request to the wireless carrier by a transaction card processing system if the transaction is flagged by the transaction card processing system as a transaction with a compromised transaction card.

19. The method of claim 18, wherein sending the request to the card holder's wireless carrier further comprises flagging all transactions with the transaction card by the transaction card processing system if information is received by the transaction card processing system that the card holder's transaction card has been compromised.

20. The method of claim 1, wherein sending the request to the card holder's wireless carrier further comprises sending the request to the wireless carrier by an ATM card processing system if factors indicative of a likelihood of a fraudulent transaction are identified by the ATM card processing system.

21. The method of claim 20, wherein sending the request to the card holder's wireless carrier if factors indicative of a likelihood of a fraudulent transaction are identified further comprises sending the request to the wireless carrier by the ATM card processing system if a predetermined number of incorrect card holder identification information entry attempts by the card user are received by the ATM card processing system.

22. The method of claim 1, wherein sending the request to the card holder's wireless carrier further comprises sending the request to the wireless carrier by a transaction card processing system if the transaction is flagged by the transaction card processing system as likely to be a fraudulent transaction.

23. The method of claim 22, wherein sending the request to the card holder's wireless carrier further comprises flagging the transaction by the transaction card processing system as likely to be fraudulent if an approximation of the user location by the transaction card processing system via a trace of a network connected computing device disposed at the user location determines the user location to be outside a pre-defined home geographic area of the card holder.

24. The method of claim 22, wherein sending the request to the card holder's wireless carrier further comprises flagging the transaction by the transaction card processing system as likely to be fraudulent if an approximation of the user location by the transaction card processing system via a trace of a land line connected telephonic device disposed at the user location determines the user location to be outside a pre-defined home geographic area of the card holder.

25. The method of claim 1, wherein sending the request to the card holder's wireless carrier further comprises sending the request to the wireless carrier by an access control card processing system.

26. The method of claim 1, wherein receiving the location information for the card holder's mobile phone further comprises receiving the location information from the card holder's wireless carrier by a transaction card processing system.

27. The method of claim 1, wherein receiving the location information for the card holder's mobile phone further comprises receiving the location information from the card holder's wireless carrier by an ATM card processing system.

28. The method of claim 1, wherein receiving the location information for the transaction card holder's mobile phone further comprises receiving the location information from the card holder's wireless carrier by an access control card processing system.

29. The method of claim 1, wherein allowing the transaction to proceed further comprises allowing the transaction to proceed by a transaction card processing system if the location of the card holder's mobile phone is determined to be proximate a merchant's point-of-sale terminal disposed at the user location.

30. The method of claim 1, wherein allowing the transaction to proceed further comprises allowing the transaction to proceed by an ATM card processing system if the location of the card holder's mobile phone is determined to be proximate an ATM machine disposed at the user location.

31. The method of claim 1, wherein allowing the transaction to proceed further comprises allowing the transaction to proceed by a transaction card processing system if the location of the card holder's mobile phone is determined to be proximate a network connected computing device disposed at the user location.

32. The method of claim 1, wherein allowing the transaction to proceed further comprises allowing the transaction to proceed by a transaction card processing system if the location of the card holder's mobile phone is determined to be proximate a land line connected telephonic device disposed at the user location.

33. The method of claim 1, wherein allowing the transaction to proceed further comprises allowing the transaction to proceed by an access control card processing system if the location of the card holder's mobile phone is determined to be proximate an access control terminal disposed at the user location.

34. The method of claim 1, wherein denying the transaction further comprises denying the transaction by a transaction card processing system if the location of the card holder's mobile phone is determined to be at a location other than proximate a merchant's point-of-sale terminal disposed at the user location.

35. The method of claim 1, wherein denying the transaction further comprises denying the transaction by an ATM card processing system if the location of the card holder's mobile phone is determined to be at a location other than proximate an ATM machine disposed at the user location.

36. The method of claim 1, wherein denying the transaction further comprises denying the transaction by a transaction card processing system if the location of the card holder's mobile phone is determined to be at a location other than proximate a network connected computing device disposed at the user location.

37. The method of claim 1, wherein denying the transaction further comprises denying the transaction by a transaction card processing system if the location of the card holder's mobile phone is determined to be at a location other than proximate a land line connected telephonic device disposed at the user location.

38. The method of claim 1, wherein denying the transaction further comprises denying the transaction by an access control card processing system if the location of the card holder's mobile phone is determined to be at a location other than proximate an access control terminal disposed at the user location.

39. A system for mitigating transaction card fraud, comprising:
a transaction card processing system adapted for receiving transaction card information for a user in connection with a transaction attempted by the user at a user location;
the transaction card processing system having means for sending a request to a wireless carrier of a mobile phone of a holder of the transaction card to return location information of the mobile phone of the card holder utilizing location based services provided by the card holder's wireless carrier and means for receiving the location information for the card holder's mobile phone from the card holder's wireless carrier; and
the transaction card processing system being further adapted for allowing the transaction to proceed if the location of the card holder's mobile phone is determined to be proximate the user location and for denying the transaction if the location of the card holder's mobile phone is determined to be at a location other than the user location.

40. The system of claim 39, wherein the transaction card processing system is further adapted for receiving the transaction card information via a merchant's point-of-sale terminal disposed at the user location.

41. The system of claim 40, wherein the transaction card processing system is further adapted for receiving the transaction card information via the merchant's point-of-sale terminal through swiping the card through a card reader of the terminal.

42. The system of claim 40, wherein the transaction card processing system is further adapted for receiving the information via the terminal by manual input.

43. The system of claim 40, wherein the transaction card processing system is further adapted for receiving the information via a phone call by the merchant's point-of-sale terminal to the transaction card processing system.

44. The system of claim 40, wherein the transaction card processing system is further adapted for receiving the information via a direct connection between the merchant's point-of-sale terminal and the transaction card processing system.

45. The system of claim 39, wherein the transaction card processing system further comprises an ATM card processing system adapted for receiving ATM card information via an ATM machine disposed at the user location.

46. The system of claim 39, wherein the transaction card processing system further comprises an ATM card processing system adapted for receiving ATM card information via a merchant point-of-sale terminal disposed at the user location.

47. The system of claim 39, wherein the transaction card processing system is further adapted for receiving the transaction card information via a network connected computing device disposed at the user location.

48. The system of claim 47, wherein the transaction card processing system is further adapted for approximating the user location via a trace of the network connected computing device.

49. The system of claim 39, wherein the transaction card processing system is further adapted for receiving the transaction card information via a land line connected telephonic device disposed at the user location.

50. The system of claim 49, wherein the transaction card processing system is further adapted for approximating the user location via a trace of the land line connected telephonic device.

51. The system of claim 39, wherein the transaction card processing system further comprises an access control card system adapted for receiving access control card information via an access control terminal disposed at the user location.

52. The system of claim 51, wherein the access control card system is further adapted for receiving the access control card information via the access control terminal through swiping the card through a card reader of the terminal.

53. The system of claim 39, wherein the transaction card processing system is further adapted for sending the request to the wireless carrier system if the transaction is flagged by a fraud detection system of the transaction card processing system as likely to be fraudulent.

54. The system of claim 53, wherein the fraud detection system of the transaction card processing system is adapted for flagging the transaction as likely to be fraudulent if factors indicative of the likelihood of a fraudulent transaction are identified by the fraud detection system.

55. The system of claim 54, wherein the fraud detection system of the transaction card processing system is further adapted for evaluating the transaction card information according to pre-defined parameters for detecting factors indicative of the likelihood of a fraudulent transaction.

56. The system of claim 39, wherein the transaction card processing system is further adapted for sending the request to the wireless carrier if the transaction is flagged by the transaction card processing system as a transaction with a compromised transaction card.

57. The system of claim 56, wherein the transaction card processing system is further adapted for flagging all transactions with the transaction card if information is received by the transaction card processing system that the card holder's transaction card has been compromised.

58. The system of claim 39, wherein the transaction card processing system further comprises an ATM card processing system adapted for sending the request to the wireless carrier if factors indicative of a likelihood of a fraudulent transaction are identified by the ATM card processing system.

59. The system of claim 58, wherein the ATM card processing system is further adapted for sending the request to the wireless carrier if a predetermined number of incorrect card holder identification information entry attempts by the card user are received by the ATM card processing system.

60. The system of claim 39, wherein the transaction card processing system is further adapted for sending the request to the wireless if the transaction is flagged by the transaction card processing system as likely to be a fraudulent transaction.

61. The system of claim 60, wherein the transaction card processing system is further adapted for flagging the transaction as likely to be fraudulent if an approximation of the user location by the transaction card processing system via a trace of a network connected computing device disposed at the user location determines the user location to be outside a pre-defined home geographic area of the card holder.

62. The system of claim 60, wherein the transaction card processing system is further adapted for flagging the transaction as likely to be fraudulent if an approximation of the user location by the transaction card processing system via a trace of a land line connected telephonic device disposed at the user location determines the user location to be outside a pre-defined home geographic area of the card holder.

63. The system of claim 39, wherein the transaction card processing system further comprises by an access control card processing system adapted for sending the request to the wireless carrier.

64. The system of claim 39, wherein the transaction card processing system is further adapted for receiving the location information from the card holder's wireless carrier.

65. The system of claim 39, wherein the transaction card processing system further comprises an ATM card processing system adapted for receiving the location information from the card holder's wireless carrier.

66. The system of claim 39, wherein the transaction card processing system further comprises an access control card processing system adapted for receiving the location information from the card holder's wireless carrier.

67. The system of claim 39, wherein the transaction card processing system is further adapted for allowing the transaction to proceed if the location of the card holder's mobile phone is determined to be proximate a merchant's point-of-sale terminal disposed at the user location.

68. The system of claim 39, wherein the transaction card processing system further comprises an ATM card processing system adapted for allowing the transaction to proceed if the location of the card holder's mobile phone is determined to be proximate an ATM machine disposed at the user location.

69. The system of claim 39, wherein the transaction card processing system is further adapted for allowing the transaction to proceed if the location of the card holder's mobile phone is determined to be proximate a network connected computing device disposed at the user location.

70. The system of claim 39, wherein the transaction card processing system is further adapted for allowing the transaction to proceed if the location of the card holder's mobile phone is determined to be proximate a land line connected telephonic device disposed at the user location.

71. The system of claim 39, wherein the transaction card processing system further comprises an access control card processing system adapted for allowing the transaction to proceed if the location of the card holder's mobile phone is determined to be proximate an access control terminal disposed at the user location.

72. The system of claim 39, wherein the transaction card processing system is further adapted for denying the transaction if the location of the card holder's mobile phone is determined to be at a location other than proximate a merchant's point-of-sale terminal disposed at the user location.

73. The system of claim 39, wherein the transaction card processing system further comprises an ATM card processing system adapted for denying the transaction if the location of the card holder's mobile phone is determined to be at a location other than proximate an ATM machine disposed at the user location.

74. The system of claim 39, wherein the transaction card processing system is further adapted for denying the transaction if the location of the card holder's mobile phone is determined to be at a location other than proximate a network connected computing device disposed at the user location.

75. The system of claim 39, wherein the transaction card processing system is further adapted for denying the transaction if the location of the card holder's mobile phone is determined to be at a location other than proximate a land line connected telephonic device disposed at the user location.

76. The system of claim 39, wherein the transaction card processing system further comprises an access control card processing system adapted for denying the transaction if the location of the card holder's mobile phone is determined to be at a location other than proximate an access control terminal disposed at the user location.
